(19) United States
(12) Patent Application Publication
(10) Pub. No.: US 2017/0214251 A1
(43) Pub. Date: Jul. 27, 2017

(54) Energy Storage Systems With Enhanced Storage and Discharge Response Allocation

(71) Applicant: General Electric Company, Schenectady, NY (US)

(72) Inventors: Parag Rameshchandra Dharmadhikari, Neufahrn (DE); David Ray Hudnall, Simpsonville, SC (US)

(21) Appl. No.: 15/002,637

(22) Filed: Jan. 21, 2016

(51) Int. Cl. H02J 5/00; H01M 10/46; H02P 9/00; F03D 7/00; F03D 9/00; H02K 7/18; H01M 10/42; H01M 2/10

(52) U.S. Cl. CPC H02J 5/00; H01M 10/425; H01M 10/46; H01M 2/1077; F03D 7/00; F03D 9/002; H02K 7/183; H02P 9/00; H01M 2220/10; H01M 2010/4271

(57) ABSTRACT

In one embodiment, an energy storage system includes a plurality of energy storage banks. The plurality of energy storage banks include a first set of one or more energy storage banks and a second set of one or more energy storage banks. The first set of the energy storage banks is associated with a faster charge/discharge rate relative to the second set of energy storage banks. The energy storage system includes at least one control device that is configured to control the first set of energy storage banks to accept or discharge energy in response to fluctuations in a power signal associated with a first frequency; and is further configured to control the second set of energy storage banks to accept or discharge energy in response to fluctuations in the power signal associated with a second frequency. The first frequency is greater than the second frequency.

### FIELD OF THE INVENTION

The present subject matter relates generally to power systems, and more particularly to power systems that employ energy storage systems.

### BACKGROUND OF THE INVENTION

Energy storage systems, such as energy storage systems that include arrays of batteries or other energy storage devices, are increasingly becoming a preferred option to provide stabilization services to an energy generation and distribution network (i.e., an “energy grid”). In particular, energy storage systems can provide load balancing, frequency regulation, or other stabilization services for an energy grid.

When coupled to an energy grid, such energy storage systems may be tasked with providing stabilization services in response to aggressive peak and unevenly distributed energy demands experienced by the energy grid. As one example, energy storage systems can assist grid operators in managing fluctuations in voltage caused by sudden changes in demand and/or supply, such as changes in supply from intermittent renewable power sources like solar power generation assets and/or wind power generation assets.

Thus, a power system can experience both shorter term and longer term energy cycles. Such shorter term and longer term energy cycles may respectively result in high frequency fluctuations and low frequency fluctuations in a power signal (e.g., a voltage or current signal). High frequency fluctuations may also take the form of ripple current.

Providing stabilization services in response to high frequency fluctuations in the power signal (e.g., by attempting to very quickly accept or discharge energy) can result in an undesirable amount of stress being placed on certain components of the energy storage system over time. For example, an energy storage asset (e.g., a battery) that is less equipped to quickly charge or discharge energy can dissipate an undesirable amount of heat while attempting to quickly respond to high frequency fluctuations in the power signal. This can undesirably degrade the life span of the energy storage asset. As such, continued exposure to high frequency stresses can result in a high failure rate of the energy storage assets and/or reduced life span for the energy storage assets. Such high failure rates lead to poor system reliability and require intensive maintenance for the energy storage system.

Certain energy storage system designs have attempted to counteract such high failure rates by building excess capacity into the system from the beginning. However, such strategy requires more than an optimal number of storage assets for a given project, and therefore can unnecessarily increase the cost of the storage system. Further, such strategy may not resolve the underlying problem that results in stress of the energy storage assets in the first place.

### BRIEF DESCRIPTION OF THE INVENTION

Aspects and advantages of embodiments of the present disclosure will be set forth in part in the following description, or may be learned from the description, or may be learned through practice of the embodiments.

One example aspect of the present disclosure is directed to an energy storage system. The energy storage system includes a plurality of energy storage banks that respectively include one or more energy storage devices. The plurality of energy storage banks include a first set of one or more energy storage banks and a second set of one or more energy storage banks. The first set of the energy storage banks is associated with a faster charge/discharge rate relative to the second set of energy storage banks. The energy storage system includes at least one control device that is configured to control the first set of energy storage banks to accept or discharge energy in response to fluctuations in a power signal associated with a first frequency. The at least one control device is further configured to control the second set of energy storage banks to accept or discharge energy in response to fluctuations in the power signal associated with a second frequency. The first frequency is greater than the second frequency.

Another example aspect of the present disclosure is directed to a method to control an energy storage system. The method includes electrically coupling the energy storage system to a power system. The energy storage system includes a plurality of energy storage banks that respectively include one or more energy storage devices. The plurality of energy storage banks include at least a first energy storage bank and a second energy storage bank. The first energy storage bank has a relatively faster charge/discharge rate than the second energy storage bank. The method includes controlling, by at least one control device, the first energy storage bank to accept or discharge energy in response to fluctuations in a power signal associated with a first frequency. The method includes controlling, by the at least one control device, the second energy storage bank to accept or discharge energy in response to fluctuations in the power signal associated with a second frequency. The first frequency is greater than the second frequency.

Yet another example aspect of the present disclosure is directed to wind power system. The wind power system includes a wind turbine power system. The wind power system includes a first energy storage device. The wind power system includes a first power converter electrically coupled between the first energy storage device and the wind turbine power system. The wind power system includes a second energy storage device, wherein the second energy storage device has a relatively slower charge/discharge rate than the first energy storage device. The wind power system includes a second power converter electrically coupled between the second energy storage device and the wind turbine power system. The wind power system includes at least one control device. The at least one control device controls the first power converter according to a first time constant and controls the second power converter according to a second time constant. The first time constant is relatively smaller than the second time constant such that the first power converter enables the first energy storage device to accept and discharge energy relatively faster than the second power converter enables the second energy storage device to accept and discharge energy.

Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example energy storage system according to example embodiments of the present disclosure;

FIG. 2 depicts a schematic of an example energy storage system according to example embodiments of the present disclosure;

FIG. 3 depicts a block diagram of an example system controller of an energy storage system according to example embodiments of the present disclosure;

FIG. 4 depicts a block diagram of an example control configuration of an energy storage system according to example embodiments of the present disclosure;

FIG. 5 depicts a flow diagram of an example control method according to example embodiments of the present disclosure;

FIG. 6 depicts a flow diagram of an example control method according to example embodiments of the present disclosure; and

FIG. 7 depicts an example wind turbine system according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to energy storage systems that feature an enhanced configuration for allocation of response to energy cycles. The configuration and associated control algorithms improve the reliability and life span of the storage system. In particular, one example energy storage system includes a plurality of energy storage banks that respectively include one or more energy storage devices. The plurality of energy storage banks include a first set of one or more energy storage banks and a second set of one or more energy storage banks. The first set of the energy storage banks is associated with a faster charge/discharge rate relative to the second set of energy storage banks. In addition, the example energy storage system includes at least one control device that is configured to control the first set of energy storage banks to accept or discharge energy in response to high frequency fluctuations in a power signal of an energy grid; and to control the second set of energy storage banks to accept or discharge energy in response to low frequency fluctuations in the power signal of the energy grid.

Thus, the first set of energy storage banks that have a faster charge/discharge rate (i.e., are better equipped to quickly accept or discharge energy) are used to respond to the high frequency fluctuations in the power signal, while the second set of energy storage banks that have a smaller charge discharge rate (i.e., are less equipped to quickly accept or discharge energy) are used to respond to the low frequency fluctuations in the power signal.

As one example, each of the first set of energy storage banks can include one or more ultracapacitors and/or one or more lithium-ion batteries. As another example, each of the second set of energy storage banks can includes one or more sodium metal halide batteries.

In some implementations, the first set of energy storage banks provide about 8 to 15 percent of a total storage capacity of all of the energy storage banks in the energy storage system. For example, the first set of energy storage banks can provide 10 percent of the total storage capacity.

Further, in some implementations, the first set of energy storage banks can be located physically closer to a system transformer of the energy storage system that electrically connects the energy storage banks to the energy grid. As such, in some implementations, the first set of energy storage banks may be denominated as “front end” storage banks, while the second set of energy storage banks may be denominated as the “main” storage banks.

Such configuration can enable the quick cycles of the energy grid to be absorbed or otherwise stabilized by the faster storage devices of the first set of energy storage banks. Therefore, the first set of energy storage banks act as a buffer to prevent such quick cycles from being passed to the main storage banks. In addition, one or more power converters associated with the main storage banks are enabled to remain in a constant status for a longer duration. The use of faster storage devices in this fashion reduces the expose of the main storage banks to the stresses associated with high frequency fluctuations, thereby enhancing the life span and reducing the failure rates of such main storage banks.

In some implementations, the energy storage system further includes a plurality of power converters respectively associated with the plurality of energy storage banks. The power converter for each energy storage bank can convert the power signal of the energy grid (e.g., a stepped down version of such power signal) to a direct current bank signal. Further, in some implementations, the energy storage system further includes a plurality of controllers respectively associated with the plurality of energy storage banks.

The controller for each energy storage bank can control the corresponding power converter for such energy storage bank according to a time constant associated with such power converter. For example, the respective time constants for power converters of the first set of energy storage banks can be smaller than the respective time constants for the power converters of the second set of energy storage banks, such that the power converters of the first set of energy storage banks enable the first set of energy storage banks to more quickly respond to fluctuations in the power signal than the power converters of the second set of energy storage banks enable the second set of energy storage banks to respond.

In addition, in some implementations of the present disclosure, the controller for each power converter can periodically update or adjust one or more control parameters (e.g., the time constant) for the corresponding power converter. For example, each controller can implement or otherwise operate responsive to a feedback loop that evaluates one or more performance parameters of the corresponding power converter and/or energy storage bank. As an example, the controller can monitor one or more characteristics of a current associated with the corresponding power converter and/or energy storage bank (e.g., a current of a direct current bank signal) to evaluate the performance of the corresponding power converter and/or energy storage bank. Based on such evaluation, the controller can adjust the one or more control parameters (e.g., the time constant) for the corresponding power converter to adjust the performance of the corresponding power converter and/or energy storage bank as desired (e.g., to cause the performance to more precisely conform to one or more target performance parameters).

Thus, the energy storage system can include a centralized configuration with a distributed control scheme. Such distributed control can improve the maintainability of the energy storage system, as each storage bank can be controlled according to an independent response time constant. Further, random failures can be strategically shifted to organized failures, as failed energy storage banks can be isolated and selectively decommissioned. In addition, distributed control of the plurality of energy storage banks can assist in resolving differences between the various states of charge of different energy storage banks, as the banks are not coupled on the same direct current bus.

In this way, a technical effect of example embodiments of the present disclosure can include improving the life span and reliability of an energy storage system. In particular, the configurations and control schemes of example embodiments of the present disclosure can reduce the stress applied to a main body of energy storage assets by high frequency fluctuations in a power signal by using front end energy storage assets with a relatively faster charge/discharge rate to stabilize such fluctuations. Thus, the life span of such main body of assets can be increased and the failure rate reduced, thereby improving the reliability of the energy storage system as a whole.

Additional technical effects of example embodiments of the present disclosure include a cleaner design; a configuration which improves the maintainability of the system; and avoiding excess capacity designed solely to cater to failure rate, thereby enabling the storage system to have an optimum storage capacity. Example embodiments of the present disclosure may also have the commercial advantage of a lower initial cost due to optimum storage capacity (e.g., by eliminating the requirement to build in excess capacity); a lower operational cost due to a lower failure rate; savings on maintenance costs as a reduced number of visits to the system are required; and an increase in revenue due to a reduced number of stoppages.

Example schemes, systems, methods, and circuitry to accomplish these technical effects will be discussed further below with reference to the Figures. Further, although the example aspects of the present disclosure are discussed with particular reference to stabilization of a power signal received from an energy grid, the present disclosure is equally applicable to other power systems, such as power generation systems, power expending systems, or other power storage systems.

With reference now to the Figures, example embodiments of the present disclosure will be discussed in further detail.

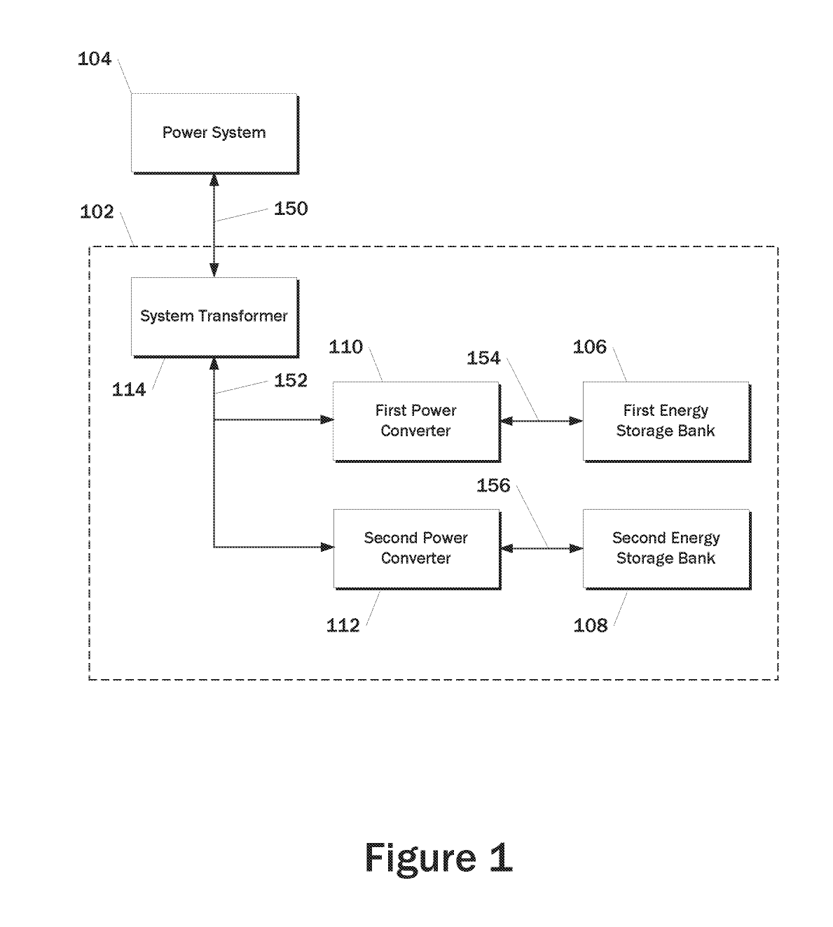

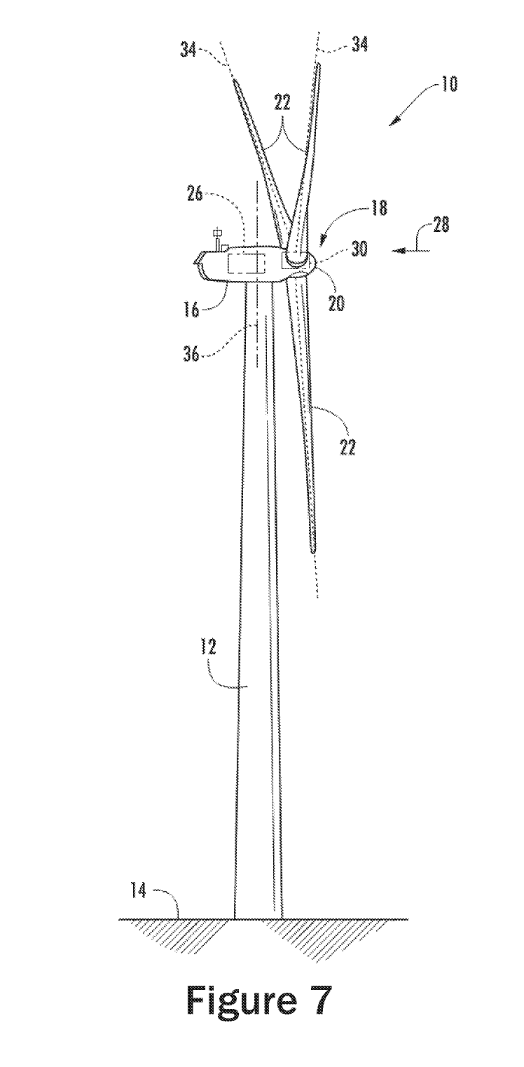

FIG. 1 depicts a block diagram of an example energy storage system 102 according to example embodiments of the present disclosure. The energy storage system 102 is electrically coupled to a power system 104. For example, the power system 104 can be an energy generation and distribution network (i.e., an “energy grid”) or other power systems such as energy generator power systems, electric rail power systems, and aircraft, watercraft, or other vehicular power systems. In another example, the power system 104 can be a wind turbine power system associated with a wind turbine, for example, as illustrated in FIG. 7.

The energy storage system 102 includes a first energy storage bank 106 and a second energy storage bank 108. According to an aspect of the present disclosure, the first energy storage bank 106 has a relatively faster charge/discharge rate than the second energy storage bank 108. Stated differently, the first energy storage bank 106 can more quickly accept or discharge energy in response to a change in a controlling parameter (e.g., a change in a voltage or a current of a power signal 150 of the power system 104).

In one example, the first energy storage bank 106 can include one or more lithium-ion batteries, ultracapacitors (also known as supercapacitors, electric double-layer capacitors, and/or electrochemical double layer capacitors), or other energy storage devices that exhibit a relatively large charge discharge rate. As another example, the second energy storage bank 108 can include one or more sodium metal halide batteries or other energy storage devices that exhibit a relatively smaller charge discharge rate. For example, each energy storage bank 106 and 108 can include one or more energy storage devices connected in a series configuration or in other configurations such as an array. Thus, in some implementations, the energy storage system 102 can be denominated as a battery energy storage system or a “BESS.”

Each energy storage bank can be electrically coupled to a power converter. As examples, the first energy storage bank 106 is electrically coupled to a first power converter 110, while the second energy bank 108 is electrically coupled to a second power converter 112. Each of the power converters is coupled to a system transformer 114 of the energy storage system 102. The system transformer 114 can electrically couple the energy storage system 102 to the power system 104.

More particularly, the power system 104 can have a power signal 150 associated therewith. For example the power signal 150 can have or exhibit various properties such as a voltage and a current. In some implementations, the power signal 150 can include multiple signals, such as, for example, a three-phase alternating current power signal. As one example, the power signal 150 can be a 50 Hz or 60 Hz alternating current power signal suitable for a utility grid.

The system transformer 114 can transform the power signal 150 into a stepped-down version of the power signal 152. For example, the stepped-down version of the power signal 152 can correspond to the power signal 150, but at a reduced voltage.

The power converters 110 and 112 can respectively convert the stepped-down version of the power signal 152 into respective bank signals 154 and 156. More particularly, in some implementations, the first power converter 110 can convert an alternating current power signal 152 into a direct current bank signal 154, while the second power converter 112 converts the alternating current power signal 152 into a direct current bank signal 156.

In some implementations, the first power converter 110 and the second power converter 112 are respective inverters. The power converters 110 and 112 can include one or more electronic switching elements, such as insulated gate bipolar transistors (IGBT). The electronic switching elements can be controlled (e.g., using pulse width modulation) to enable the charge or discharge of energy to or from the respective energy storage banks. In addition, the electronic switching elements can be controlled to condition DC power received or provided to the respective energy storage banks.

In some implementations, as will be discussed further below, the operation of each of the first power converter 110 and second power converter 112 can be controlled by one or more control devices. As one example, the first power converter 110 can be controlled by a first controller, while the second power converter 112 is controlled by a second controller, thereby providing independent, distributed control.

In addition, as will be discussed further below, each power converter can be controlled according to a respective time constant. Thus, for example, the first power converter 110 can be controlled according to a first time constant, while the second power converter 112 is controlled according to a second time constant. In some implementations, the first time constant is relatively smaller than the second time constant.

More particularly, according to an aspect of the present disclosure, the first energy storage bank 106 and first power converter 110 can be controlled to respond to (e.g., provide stabilization services with respect to) high frequency fluctuations in the power signal 150 of the power system 104, while the second energy storage bank 108 and second power converter 112 can be controlled to respond to (e.g., provide stabilization services with respect to) low frequency fluctuations in the power signal 150 of the power system 104.

In some implementations, the first energy storage bank 106 and the second energy storage bank 108 are connected in parallel. In other implementations, the first energy storage bank 106 and the second energy storage bank 108 are connected in a star configuration.

Further, the energy storage system 102 can include various other devices, such as switches, relays, contactors, etc. which are used for protection of the energy storage system 102.

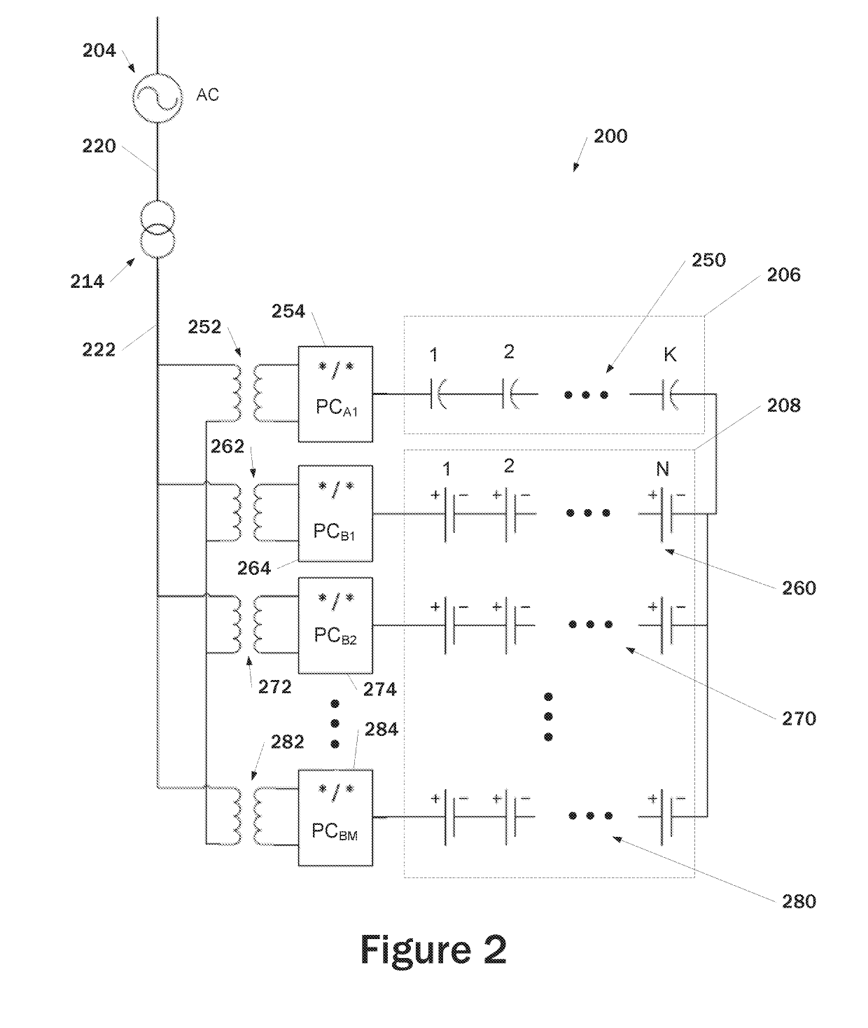

In addition, it should be appreciated that FIG. 1 illustrates a simplified version of an energy storage system of the present disclosure for the purpose of explaining particular principles of the present disclosure. Energy storage systems of the present disclosure can include any number of energy storage banks. For example, in some implementations, the energy storage systems of the present disclosure can be multi-megawatt battery storage systems that include a plurality of power blocks, with each power block including a plurality of battery racks, each battery rack including a plurality of battery modules, and each battery module including a plurality of cells. A relatively more complex illustration of an example energy storage system of the present disclosure is provided by FIG. 2.

FIG. 2 depicts a schematic of an example energy storage system 200 according to example embodiments of the present disclosure. The energy storage system 200 includes a first set 206 of one or more energy storage banks and a second set 208 of one or more energy storage banks.

The energy storage system 200 is electrically coupled to a power system 204 via a system transformer 214. For example, the power system 204 can be an energy generation and distribution network (i.e., an “energy grid”) or other power systems such as energy generator power systems (e.g., a wind turbine power system), electric rail power systems, or aircraft, watercraft, or other vehicular power systems.

The system transformer 214 can electrically couple the energy storage system 200 to the power system 204. More particularly, the power system 204 can have a power signal 220 associated therewith. For example the power signal 220 can have or exhibit various properties such as a voltage and a current. In some implementations, the power signal 220 can include multiple signals, such as, for example, a three-phase alternating current power signal. As one example, the power signal 220 can be a 50 Hz or 60 Hz alternating current power signal suitable for a utility grid. The system transformer 214 can transform the power signal 220 into a stepped-down version 222 of the power signal. For example, the stepped-down version 222 of the power signal can correspond to the power signal 220, but at a reduced voltage.

The first set 206 and the second set 208 of energy storage banks can include any number of energy storage banks. In the particular illustrated example, the first set of energy storage banks 206 includes a solitary energy storage bank 250. However, such solitary bank is provided as one example only. The first set of energy storage banks 206 can include any number of energy storage banks.

Further, in the particular illustrated example, the second set of energy storage banks 208 includes M energy storage banks, illustrated as a first energy storage bank 260, a second energy storage bank 270 and an M^{th} energy storage bank 280.

Each energy storage bank can include a number of energy storage devices. As examples, the energy storage bank 250 is illustrated as including K ultracapacitors, while the energy storage bank 260 is illustrated as including N batteries.

Each of the energy storage banks 250, 260, 270, and 280 can be electrically coupled to a corresponding power converter that is, in turn, coupled to a bank transformer. As examples, the energy storage bank 250 is electrically coupled to a power converter 254 which is, in turn, electrically coupled to a bank transformer 252; the energy storage bank 260 is electrically coupled to a power converter 264 which is, in turn, electrically coupled to a bank transformer 262; the energy storage bank 270 is electrically coupled to a power converter 274 which is, in turn, electrically coupled to a bank transformer 272; the energy storage bank 280 is electrically coupled to a power converter 284 which is, in turn, electrically coupled to a bank transformer 282.

Each of the bank transformers 252, 262, 272, and 282 can further step down or reduce the voltage of the version 222 of the power signal received from the system transformer 214.

The power converters 254, 264, 274, and 284 can convert the version of the power signal respectively received from the respective bank transformers 252, 262, 272, and 282 into respective bank signals. More particularly, in some implementations, each power converter can convert an alternating current power signal received from its corresponding bank transformer into a direct current bank signal.

In some implementations, the power converters 254, 264, 274, and 284 are respective inverters. The power converters 254, 264, 274, and 284 can include one or more electronic switching elements, such as insulated gate bipolar transistors (IGBT). The electronic switching elements can be controlled (e.g., using pulse width modulation) to enable the charge or discharge of energy stored at the respective energy storage banks. In addition, the electronic switching elements can be controlled to condition DC power received or provided to the respective energy storage banks.

In some implementations, as will be discussed further below, the operation of each of the power converters 254, 264, 274, and 284 can be controlled by one or more control devices. In addition, as will be discussed further below, each of the power converters 254, 264, 274, and 284 can be controlled according to a respective time constant. Thus, for example, the power converter 254 can be controlled according to a first time constant, while the power converter 264 can be controlled according to a second time constant.

In some implementations, the time constant associated with each respective power converter for the first set 206 of energy storage banks is relatively smaller than the time constant associated with each respective power converter for the second set 208 of energy storage banks, such that each of the first set 206 of energy storage banks is enabled to exhibit a larger or faster charge discharge rate than each of the second set 208 of energy storage banks.

In some implementations, the respective positions of the power converters 254, 264, 274, and 284 and their corresponding bank transformers 252, 264, 274, and 284 can be swapped. For example, the bank transformer 252 can be a DC to DC transformer electrically coupled between the energy storage bank 250 and the power converter 254.

According to an aspect of the present disclosure, the first set 206 of energy storage banks can be controlled to respond to (e.g., provide stabilization services with respect to) high frequency fluctuations in the power signal 220 of the power system 204, while the second set 208 of energy storage banks can be controlled to respond to (e.g., provide stabilization services with respect to) low frequency fluctuations in the power signal 220 of the power system 204.

In some implementations, each of the first set 206 of energy storage banks and each of the second set 208 of energy storage banks can be respectively connected in parallel. In other implementations, each of the first set 206 of energy storage banks and each of the second set 208 of energy storage banks can be connected in a star configuration.

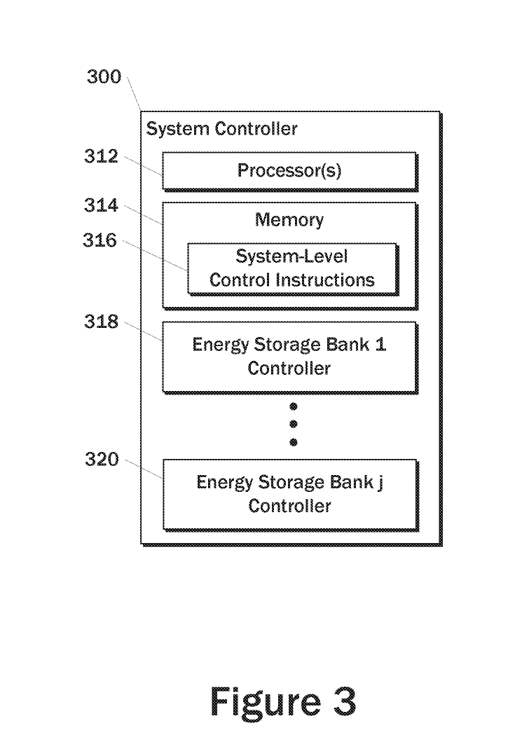

FIG. 3 depicts a block diagram of an example system controller 300 of an energy storage system according to example embodiments of the present disclosure. The system controller 300 can include one or more processors 312 and a memory 314. The memory 314 can store or provide system-level control instructions 316.

The system controller 300 can be configured to perform a variety of computer-implemented functions and/or instructions (e.g., performing the methods, steps, calculations and the like and storing relevant data as disclosed herein). The instructions 316 when executed by the processor(s) 312 can cause the processor(s) 312 to perform operations according to example aspects of the present disclosure. For instance, the instructions when executed by the processor(s) 316 can cause the processor(s) 312 to implement one or more control modules, such as the control logic as will be discussed in more detail below.

The processor 312 can include any suitable processing device such as processor, microprocessor, integrated circuit, application specific integrated circuit, programmable logic controller, field programmable gate array, etc. The processor 312 can be one processor or can be a plurality of processors that are operatively connected.

The memory 314 can generally include memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 314 can generally be configured to store suitable computer-readable instructions that, when implemented by the processor(s) 312, configure the controller 300 to perform the various functions as described herein.

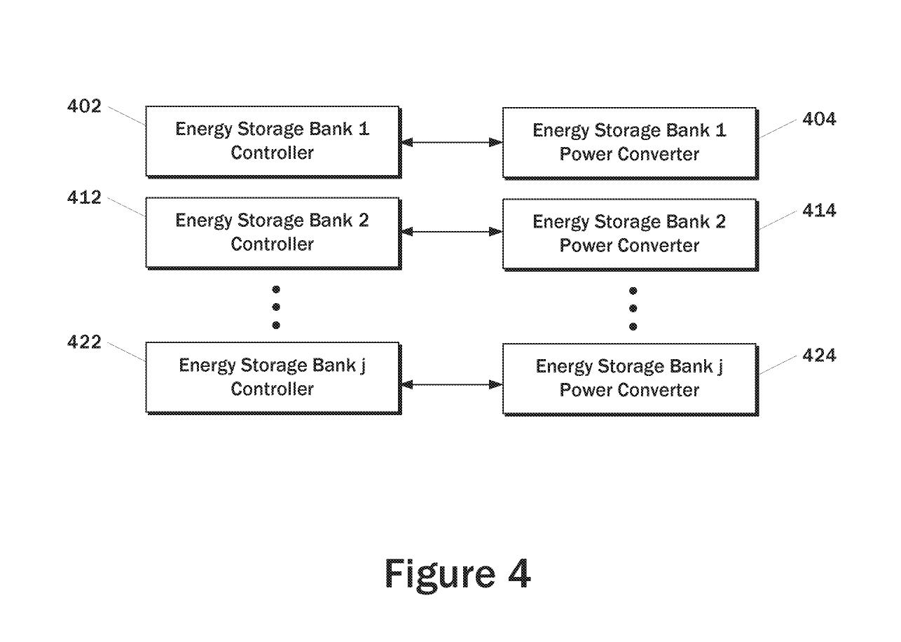

In some implementations, the system controller 300 can further include a number of individual energy storage bank controllers. For example, the system controller 300 is illustrated in FIG. 3 as including a first energy storage bank controller 318 through a j^{th} energy storage bank controller 320. In some implementations, as illustrated in FIG. 3, the controllers 318-320 are subcomponents of the system controller 300. In other implementations, the controllers 318-320 are individual, stand-alone components that are not included in the system controller 300. Each of the controllers 318-320 can control a corresponding power converter, as will be discussed below with reference to FIGS. 4-6.

As used herein, the term “controller” refers to a device or component that implements computer logic to control a component or aspect of the energy storage system. In some implementations, each controller includes one or more processing devices, such as a processor, microprocessor, integrated circuit, application specific integrated circuit, programmable logic controller, field programmable gate array, etc. In other implementations, a single processing device can implement or otherwise perform the functions of several controllers by implementing sets of instructions. A controller can be implemented in hardware, firmware, software controlling a general purpose processor, or some combination thereof.

In some implementations, the system controller 300 can be or can include a battery management system (BMS) of a BESS. The BMS can include one or more electronic devices that monitor one or more of the battery energy storage devices, such as by protecting the battery energy storage device from operating outside a safe operating mode, monitoring a state of the battery energy storage device, calculating and reporting operating data for the battery energy storage device, controlling the battery energy storage device environment, and/or any other suitable control actions.

For example, in several implementations, the BMS is configured to monitor and/or control operation of one or more energy storage devices or their associated power converters. The BMS can be, for example, a logic controller implemented purely in hardware, a firmware-programmable digital signal processor, or a programmable processor-based software-controlled computer.

FIG. 4 depicts a block diagram of an example control configuration of an energy storage system according to example embodiments of the present disclosure. In particular, the control configuration includes a plurality of controllers respectively associated with a plurality of power converters.

More particularly, the control configuration includes a first energy storage bank controller 402 that controls a first energy storage bank power converter 404; a second energy storage bank controller 412 that controls a second energy storage bank power converter 414; and a j^{th} energy storage bank controller 422 that controls a j^{th} energy storage bank power converter 424.

Each controller 402, 412, 422 can control the corresponding power converter 404, 414, 424 according to a time constant associated with such power converter. Thus, the first energy storage bank controller 402 can control the first energy storage bank power converter 404 according to a first time constant; the second energy storage bank controller 412 can controls the second energy storage bank power converter 414 according to a second time constant; and the j^{th} energy storage bank controller 422 can controls the j^{th} energy storage bank power converter 424 according to a j^{th} time constant. The time constants may be equal or differently valued. In particular, in some implementations of the present disclosure, at least a first set of the power converters have time constants that are relatively smaller (i.e., exhibit faster responsiveness) than a second set of the power converters.

In some implementations, the time constant for each power converter 404, 414, 424 can be one of a number of control parameters of the power converter. For example, the first energy storage bank controller 402 can control the first energy storage bank power converter 404 in accordance with a set of control parameters, where the first time constant is a member of such set of control parameters.

In other implementations, the time constant for each power converter 404, 414, 424 can be defined by or otherwise aggregately result from the number of control parameters of the power converter. For example, the first energy storage bank controller 402 can control the first energy storage bank power converter 404 in accordance with a set of control parameters, where control of the power converter 404 according to the set of control parameters results in the power converter 404 exhibiting or otherwise operating according to the first time constant.

In addition, in some implementations of the present disclosure, each controller 402, 412, 422 can periodically update or adjust one or more of the control parameters for the corresponding power converter 404, 414, 424. For example, each controller 402, 412, 422 can adjust the time constant of the corresponding power converter 404, 414, 424 or otherwise adjust one or more other control parameters to result in the corresponding power converter 404, 414, 424 exhibiting or otherwise operating according to an adjusted time constant.

In one example, each controller 402, 412, 422 can implement or otherwise operate responsive to a feedback loop that evaluates one or more performance parameters of the corresponding power converter 404, 414, 424 and/or energy storage bank. As an example, each controller 402, 412, 422 can monitor one or more characteristics of a current associated with the corresponding power converter 404, 414, 424 and/or energy storage bank (e.g., a current of a corresponding direct current bank signal) to evaluate the performance of the corresponding power converter 404, 414, 424 and/or energy storage bank. Based on such evaluation, each controller 402, 412, 422 can adjust the one or more control parameters (e.g., the time constant) for the corresponding power converter 404, 414, 424 to adjust the performance of the corresponding power converter 404, 414, 424 and/or energy storage bank as desired (e.g., to cause the performance to more precisely conform to one or more target performance parameters).

Thus, the energy storage system can include a distributed control scheme. Such distributed control can improve the maintainability of the energy storage system, as each storage bank can be controlled according to an independent response time constant. Further, random failures can be strategically shifted to organized failures, as failed energy storage banks can be isolated and selectively decommissioned. In addition, distributed control of the plurality of energy storage banks can assist in resolving differences between the various states of charge of different energy storage banks, as the banks are not coupled on the same direct current bus.

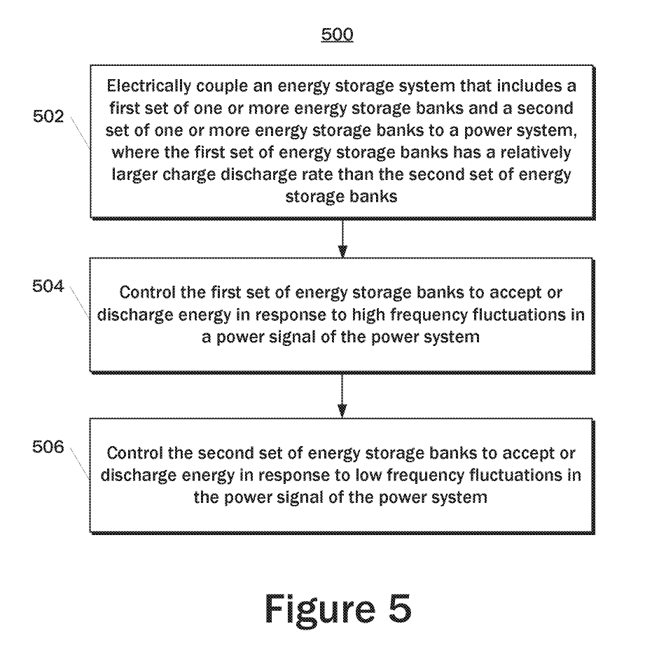

FIG. 5 depicts a flow diagram of an example control method (500) according to example embodiments of the present disclosure.

At (502), an energy storage system is electrically coupled to a power system. For example, the power system can be an energy grid. The energy storage system includes a first set of one or more energy storage banks and a second set of one or more energy storage banks. The first set of energy storage banks has a relatively faster charge/discharge rate than the second set of energy storage banks.

At (504), the first set of energy storage banks is controlled to accept or discharge energy in response to high frequency fluctuations in a power signal of the power system.

At (506), the second set of energy storage banks is controlled to accept or discharge energy in response to low frequency fluctuations in the power signal of the power system.

Thus, the first set of energy storage banks that have a faster charge/discharge rate (i.e., are better equipped to quickly accept or discharge energy) are used to respond to the high frequency fluctuations in the power signal, while the second set of energy storage banks that have a smaller charge discharge rate (i.e., are less equipped to quickly accept or discharge energy) are used to respond to the low frequency fluctuations in the power signal.

In some implementations, the energy storage system further includes a plurality of power converters respectively electrically coupled to the plurality of energy storage banks. Thus, the energy storage system includes at least a first power converter electrically coupled to at least one of the first set of energy storage banks and at least a second power converter electrically coupled to at least one of the second set of energy storage banks.

In such implementations, controlling the first set of energy storage banks at (504) to accept or discharge energy in response to high frequency fluctuations in a power signal of the power system can include controlling the first power converter according to a first set of control parameters such that the first power converter exhibits a first time constant.

Likewise, controlling the second set of energy storage banks at (506) can include controlling the second power converter according to a second set of control parameters such that the second power converter exhibits a second time constant, where the second time constant is relatively larger than the first time constant.

In some implementations, the method (500) can further include adjusting at least one of the first set of control parameters based on a first feedback loop that evaluates a first current associated with the first power converter. The method (500) can further include adjusting at least one of the second set of control parameters based on a second feedback loop that evaluates a second current associated with the second power converter.

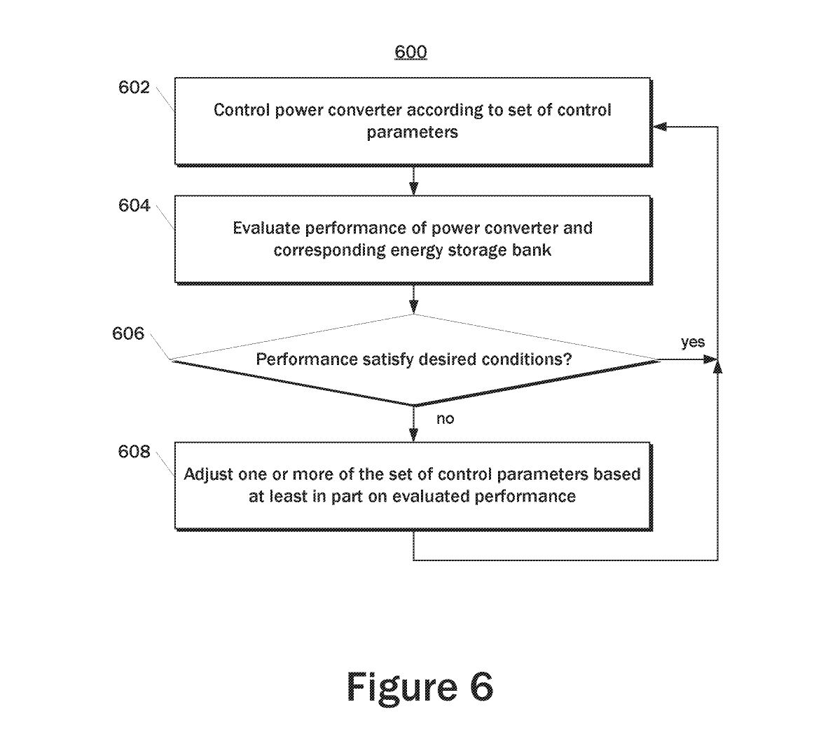

More particularly, FIG. 6 depicts a flow diagram of an example control method (600) according to example embodiments of the present disclosure. Method (600) can be performed, for example, by a controller that controls a power converter. Thus, for example, method (600) can be independently performed by each of controllers 402, 412, and 422 of FIG. 4.

At (602), a controller controls a power converter according to a set of control parameters. In some implementations, the set of control parameters includes a time constant. In other implementations, the set of control parameters can collectively define or otherwise aggregately result in performance according to a time constant.

At (604), the controller evaluates a performance of the power converter and/or a corresponding energy storage bank to which the power converter is electrically coupled. For example, the controller can evaluate one or more characteristics (e.g., amplitude, frequency, amount of fluctuation relative to peer signals) of a current associated with the power converter and/or the corresponding energy storage bank. As examples, the controller can evaluate one or more characteristics of a direct current bank signal output by the power converter; an alternating current bank signal input to the power converter; or other signals at various internal stages of the power conversion process.

At (606), it is determined whether the performance evaluated at (604) satisfied one or more desired conditions. For example, the evaluated characteristics of the current can be compared to target parameter values.

If it is determined at (606) that the performance does satisfy the conditions(s), then method (600) returns to (602) and continues to control the power converter according to the set of control parameters.

However, referring again to (606), if it is determined that the evaluated performance does not satisfy the conditions(s), then method (600) proceeds to (608). At (608), one or more of the set of control parameters are adjusted based at least in part on the evaluated performance. For example, the controller can adjust (e.g., increase or decrease) the time constant for the corresponding power converter to adjust the performance of the corresponding power converter and/or energy storage bank as desired.

After (608), the method (600) returns to (602) and controls the power converter according to the updated set of control parameters. In such fashion, the controller can implement or otherwise operate responsive to a feedback loop that evaluates one or more performance parameters of the corresponding power converter and/or energy storage bank. In particular, in one example, the controller can adjust the time constant of the power converter until the performance of the power converter and/or energy storage bank satisfies the conditions or otherwise more precisely conforms to one or more target performance parameters.

FIG. 7 depicts a perspective view of one embodiment of a wind turbine 10. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator positioned within the nacelle 16 to permit electrical energy to be produced.

The wind turbine 10 may also include a turbine control system including turbine controller 26 within the nacelle 16 or in another location associated with the wind turbine 10. In general, the turbine controller 26 may comprise one or more processing devices. Thus, in several embodiments, the turbine controller 26 may include suitable computer-readable instructions that, when executed by one or more processing devices, configure the controller 26 to perform various different functions, such as receiving, transmitting and/or executing wind turbine control signals. As such, the turbine controller 26 may generally be configured to control the various operating modes (e.g., start-up or shut-down sequences) and/or components of the wind turbine 10.

For example, the controller 26 may be configured to control the blade pitch or pitch angle of each of the rotor blades 22 (e.g. an angle that determines a perspective of the rotor blades 22 with respect to the direction 28 of the wind) to control the loading on the rotor blades 22 by adjusting an angular position of at least one rotor blade 22 relative to the wind. For instance, the turbine controller 26 may control the pitch angle of the rotor blades 22, either individually or simultaneously, by transmitting suitable control signals/commands to various pitch drivers or pitch adjustment mechanisms, such as a pitch adjustment motor of the wind turbine 10. In some implementations, each pitch adjustment motor can be further controlled by an independent pitch adjustment system. Specifically, the rotor blades 22 may be rotatably mounted to the hub 20 by one or more pitch bearing(s) (not illustrated) such that the pitch angle may be adjusted by rotating the rotor blades 22 about their pitch axes 34 using the pitch adjustment motors.

In particular, the pitch angle of the rotor blades 22 may be controlled and/or altered based at least in part on the direction 28 of the wind. For instance, the turbine controller 26 and/or a pitch adjustment controller may be configured to transmit a control signal/command to each pitch adjustment motor 32 such that one or more actuators (not shown) of the pitch adjustment motor 32 may be utilized to rotate the blades 22 relative to the hub 20.

Further, as the direction 28 of the wind changes, the turbine controller 26 may be configured to control a yaw direction of the nacelle 16 about a yaw axis 36 to position the rotor blades 22 with respect to the direction 28 of the wind, thereby controlling the loads acting on the wind turbine 10. For example, the turbine controller 26 may be configured to transmit control signals/commands to a yaw drive mechanism of the wind turbine 10 such that the nacelle 16 may be rotated about the yaw axis 30.

Still further, the turbine controller 26 may be configured to control the torque of a generator. For example, the turbine controller 26 may be configured to transmit control signals/commands to the generator in order to modulate the magnetic flux produced within the generator, thus adjusting the torque demand on the generator. Such temporary de-rating of the generator may reduce the rotational speed of the rotor blades, thereby reducing the aerodynamic loads acting on the blades 22 and the reaction loads on various other wind turbine 10 components.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An energy storage system, the energy storage system comprising:
a plurality of energy storage banks that respectively comprise one or more energy storage devices, wherein the plurality of energy storage banks comprise a first set of one or more energy storage banks and a second set of one or more energy storage banks, and wherein the first set of the energy storage banks is associated with a faster charge/discharge rate relative to the second set of energy storage banks; and
at least one control device that is configured to control the first set of energy storage banks to accept or discharge energy in response to fluctuations in a power signal associated with a first frequency, the at least one control device further configured to control the second set of energy storage banks to accept or discharge energy in response to fluctuations in the power signal associated with a second frequency, the first frequency being greater than the second frequency.

2. The energy storage system of claim 1, further comprising:
a system transformer configured to electrically connect the plurality of energy storage banks to an energy grid from which the power signal is received;
wherein the first set of energy storage banks are located physically closer to the system transformer than the second set of energy storage banks.

3. The energy storage system of claim 1, wherein the first set of energy storage banks provides about 8 to 15 percent of a total storage capacity of the plurality of energy storage banks.

4. The energy storage system of claim 3, wherein the first set of energy storage banks provides about 10 percent of the total storage capacity of the plurality of energy storage banks.

5. The energy storage system of claim 1, wherein the first set of energy storage banks comprises one or more lithium-ion batteries.

6. The energy storage system of claim 1, wherein the first set of energy storage banks comprises one or more ultracapacitors.

7. The energy storage system of claim 1, wherein the second set of energy storage banks comprises one or more sodium metal halide batteries.

8. The energy storage system of claim 1, wherein each of the first set of energy storage banks are electrically coupled in parallel with each of the second set of energy storage banks.

9. The energy storage system of claim 1, further comprising:
a plurality of power converters respectively associated with the plurality of energy storage banks, wherein the power converter for each energy storage bank is configured to convert the power signal to a direct current bank signal.

10. The energy storage system of claim 9, wherein:
the least one control device comprises a plurality of controllers respectively associated with the plurality of energy storage banks; and
the controller for each energy storage bank is configured to control the corresponding power converter for such energy storage bank according to a time constant associated with such power converter.

11. The energy storage system of claim 10, wherein the time constant associated with each of the power converters for the first set of energy storage banks is smaller than the time constant associated with each of the power converters for the second set of energy storage banks.

12. The energy storage system of claim 10, wherein:
each of the plurality of controllers is configured to periodically evaluate a performance of its corresponding power converter and adjust one or more power converter control parameters based at least in part on the evaluation.

13. A method to control an energy storage system, the method comprising:
electrically coupling the energy storage system to a power system, the energy storage system comprising a plurality of energy storage banks that respectively comprise one or more energy storage devices, wherein the plurality of energy storage banks comprise at least a first energy storage bank and a second energy storage bank, and wherein the first energy storage bank has a relatively faster charge/discharge rate than the second energy storage bank;
controlling, by at least one control device, the first energy storage bank to accept or discharge energy in response to fluctuations in a power signal associated with a first frequency; and
controlling, by the at least one control device, the second energy storage bank to accept or discharge energy in response to fluctuations in the power signal associated with a second frequency, the first frequency being greater than the second frequency.

14. The method of claim 13, wherein:
the energy storage system further comprises at least a first power converter electrically coupled to the first energy storage bank and at least a second power converter electrically coupled to the second energy storage bank;
controlling, by the at least one control device, the first energy storage bank comprises controlling, by the at least one control device, the first power converter according to a first set of control parameters such that the first power converter exhibits a first time constant;
controlling, by the at least one control device, the second energy storage bank comprises controlling, by the at least one control device, the second power converter according to a second set of control parameters such that the second power converter exhibits a second time constant, wherein the second time constant is relatively larger than the first time constant.

15. The method of claim 13, further comprising:
adjusting, by the at least one control device, at least one of the first set of control parameters based on a first feedback loop that evaluates a first current associated with the first energy storage bank; and
adjusting, by the at least one control device, at least one of the second set of control parameters based on a second feedback loop that evaluates a second current associated with the second energy storage bank.

16. A wind power system comprising:
a wind turbine power system;
a first energy storage device;
a first power converter electrically coupled between the first energy storage device and the wind turbine power system;
a second energy storage device, wherein the second energy storage device has a relatively smaller charge/discharge rate than the first energy storage device;
a second power converter electrically coupled between the second energy storage device and the wind turbine power system; and
at least one control device that controls the first power converter according to a first time constant and controls the second power converter according to a second time constant;
wherein the first time constant is relatively smaller than the second time constant such that the first power converter enables the first energy storage device to accept and discharge energy relatively faster than the second power converter enables the second energy storage device to accept and discharge energy.

17. The wind power system of claim 16, wherein the at least one control device comprises:
a first controller that controls the first power converter according to the first time constant; and
a second controller that controls the second power converter according to the second time constant.

18. The wind power system of claim 17, wherein:
the first controller periodically adjusts the first time constant based at least in part on a first current associated with the first energy storage device; and
the second controller periodically adjusts the second time constant based at least in part on a second current associated with the second energy storage device.

19. The wind power system of claim 16, wherein the first energy storage device provides about 10 percent of a total storage capacity provided by the first and the second energy storage devices.

20. The wind power system of claim 16, wherein the first energy storage device comprises one or more lithium-ion batteries or one or more ultracapacitors.
